(19) United States
(12) Patent Application Publication
(10) Pub. No.: US 2025/0020402 A1
(43) Pub. Date: Jan. 16, 2025

(54) HOLDER

(71) Applicant: Dorai Home, Inc., West Valley City, UT (US)

(72) Inventors: Jason Klug, Salt Lake City, UT (US); Kelsey O'Callaghan, Salt Lake City, UT (US)

(73) Assignee: Dorai Home, Inc., West Valley City, UT (US)

(21) Appl. No.: 18/667,762

(22) Filed: May 17, 2024

Related U.S. Application Data
(63) Continuation-in-part of application No. 29/892,613, filed on May 19, 2023.
(63) Continuation-in-part of application No. 29/925,287, filed on Jan. 23, 2024.
(60) Provisional application No. 63/624,281, filed on Jan. 23, 2024.

(51) Int. Cl. F26B 25/18

(52) U.S. Cl. CPC F26B 25/18

(57) ABSTRACT

In some implementations, a holder includes a cup having a generally frustoconical shape and an annular bottom opening and a removable bottom portion having a base and a seal. The seal may be configured to be releasably secured in the annular bottom opening via a friction fit, and the base may include diatomaceous earth.

### CROSS-REFERENCE TO RELATED APPLICATIONS

This application claims priority to U.S. patent application Ser. No. 29/892,613, titled “Toothbrush Holder,” filed May 19, 2023; U.S. patent application Ser. No. 29/925,287, titled “Holder,” filed Jan. 23, 2024; and U.S. Patent Application Ser. No. 63/624,281, titled Holder,” filed Jan. 23, 2024. This application incorporates the entire contents of the foregoing applications herein by reference.

### TECHNICAL FIELD

Implementations relate generally to holders for supporting wet articles as they dry.

### BACKGROUND

Some articles may frequently be wet or exposed to moisture, and it may be beneficial for such articles to be stowable where they can dry out. Kitchen or bathroom items, in particular—such as scrub brushes, toothbrushes and other cleaning utensils—may be frequently exposed to water.

### SUMMARY

Disclosed herein is a holder that may support wet articles while they are drying-such as, for example, scrub brushes, toothbrushes and other cleaning utensils. In some implementations, a removable base is provided that includes diatomaceous earth.

### BRIEF DESCRIPTION OF THE DRAWINGS

FIG. 1 is a top perspective view of an exemplary holder.

FIG. 2 is a side perspective view of an exemplary holder.

FIG. 3 is an exploded perspective view of an exemplary holder.

FIG. 4 is an exploded side view of an exemplary holder.

### DETAILED DESCRIPTION

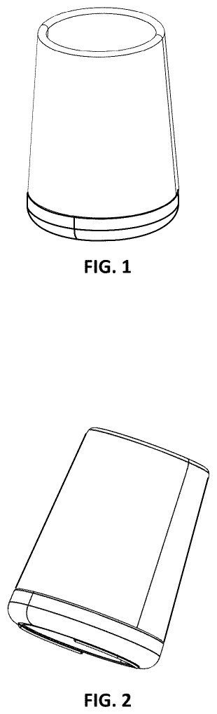

In some implementations, a holder includes a cup-like vessel and a bottom portion, such as that shown in FIG. 1. The cup-like vessel portion may have a frustoconical shape. As shown in FIGS. 2-4, the bottom portion may comprise a base, a seal, and, in some implementations, legs that dispose the base slightly above any horizontal surface upon which the holder is placed.

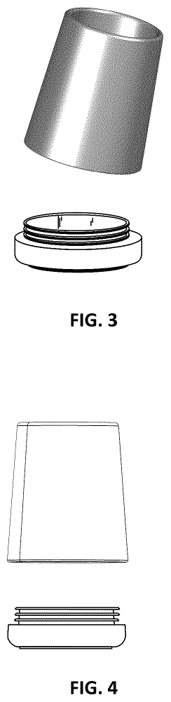

The cup-like vessel may be separable from the bottom portion (e.g., for cleaning). That is, in some implementations, such as those depicted in FIGS. 3-4, the bottom portion may include a seal that is configured to fit, via an interference or compression fit, into an annular opening at the bottom of the cup-like vessel. In particular, the seal may include one or more flanges that are configured to bend or compress to be releasably secured by the annular opening.

In some implementations, a holder such as described and illustrated herein may be employed to stow toothbrushes or other brushes that may regularly be wet. Liquid may run into the cup-like vessel, and remaining residue may be periodically cleaned from the bottom portion by removal of the bottom portion from the cup-like vessel, as depicted in FIGS. 3-4. In some implementations, both the bottom portion and the cup-like portion may be dishwasher safe to facilitate machine cleaning and sterilization.

Material for the seal may be silicone, rubber or other polymer, in some implementations. The cup-like vessel may comprise a silicone, plastic, rubber, polymer. Material for the base may comprise silicone, rubber, another polymer or an absorbent material, such as, for example, diatomaceous earth.

Several implementations have been described with reference to exemplary aspects, but it will be understood by those skilled in the art that various changes may be made and equivalents may be substituted for elements thereof without departing from the contemplated scope.

What is claimed is:

1. A holder comprising:
a cup having a generally frustoconical shape and an annular bottom opening;
a removable bottom portion having a base and a seal, the seal configured to be releasably secured in the annular bottom opening via a friction fit, wherein the base comprises diatomaceous earth.

2. The holder of claim 1, wherein the seal comprises one or more silicone flanges that are displaced or compressed when the seal is releasably secured in the annular bottom opening.
